(19) United States
(12) Patent Application Publication
(10) Pub. No.: US 2022/0050862 A1
(43) Pub. Date: Feb. 17, 2022

(54) METHOD FOR PROCESSING DISAPPEARING MESSAGES IN AN ELECTRONIC MESSAGING SERVICE AND CORRESPONDING PROCESSING SYSTEM

(71) Applicant: Orange, Paris (FR)

(72) Inventors: Cédric Floury, Chatillon Cedex (FR); Franck Meyer, Chatillon Cedex (FR)

(21) Appl. No.: 17/312,353

(22) PCT Filed: Dec. 9, 2019
(86) PCT No.: PCT/FR2019/052965

§ 371 Date: Jun. 9, 2021

(30) Foreign Application Priority Data
Dec. 21, 2018 (FR) 1873869

(51) Int. Cl. G06F 16/31; G06F 16/35

(52) U.S. Cl. CPC G06F 16/31; G06F 16/35

(57) ABSTRACT

A method for processing disappearing electronic messages from among electronic messages in a user's inbox is disclosed. At least one of the following two analysis mechanisms is implemented in order to detect whether an electronic message received in the inbox is a disappearing message: a first mechanism for analyzing the content of the electronic message, a second mechanism for detecting a label or a data field associated to the electronic message indicating a disappearing nature of the message, and in a case that one of the two analysis mechanisms detects that a received electronic message is a disappearing message, archiving the electronic message is provided.

### CROSS-REFERENCE TO RELATED APPLICATIONS

This application is filed under 35 U.S.C. §371 as the U.S. National Phase of Application No. PCT/FR2019/052965 entitled “METHOD FOR PROCESSING DISAPPEARING MESSAGES IN AN ELECTRONIC MESSAGING SERVICE AND CORRESPONDING PROCESSING SYSTEM” and filed Dec. 9, 2019, and which claims priority to FR 1873869 filed Dec. 21, 2018, each of which is incorporated by reference herein in its entirety.

### BACKGROUND

### Field

The present invention relates to the telecommunications services field and, in particular, electronic messaging services. More specifically, the present invention relates to the electronic messaging field, in particular to a method for managing electronic messages present in the inbox of a user of a messaging client and to a particular system for the implementation of the method.

### Description of the Related Technology

Electronic messaging services enable two users each equipped with a terminal connected to a data transmission network, such as the Internet network, and executing an electronic messaging application to this end, to exchange electronic messages (commonly called “electronic mail”, “mail” or “e-mails”).

The user's inbox could be rapidly filled up with electronic messages, in particular promotional electronic messages (“spam”), often undesirable, but also with electronic messages that contain useful information at a given time, but which might be disappearing messages. For example, this may consist of a message for confirming an upcoming appointment, a thanks message, an institutional communication or a very short message such as “see you soon” or “come have a coffee”.

Currently, so-called disappearing electronic messages remain in the inbox (commonly called “mailbox”) of each user and must be manually deleted. These electronic messages are not undesirable messages and must be received. Nonetheless, it might be useful that these are automatically stored or deleted in order to manage the inbox more easily and at the same time avoid the storage space reaching saturation. This is even more important as the time spent to manage someone's inbox is quite long (more than one hour each day for 26% of employees, and more than 20 minutes each day for more than 72% of employees, according to a BVA study dated in September 2012).

Furthermore, these so-called disappearing electronic messages could considerably affect the visibility of more important electronic messages, and therefore increase the risk of loss of the latter.

Hence, there is a need for a solution allowing identifying these so-called disappearing electronic messages in an inbox so that these could be stored and/or deleted, and thus facilitating management of the inbox.

### SUMMARY OF CERTAIN INVENTIVE ASPECTS

The invention addresses this need by providing a method for processing disappearing electronic messages, from among electronic messages in a user's inbox, wherein at least one of the following two analysis mechanisms is implemented in order to detect whether an electronic message received in said inbox is a disappearing message: a first mechanism for analysing the content of the electronic message, a second mechanism for detecting a label or a data field associated to the electronic message indicating the disappearing nature of said message, and in the case where one of the two analysis mechanisms detects that a received electronic message is a disappearing message, a step of archiving said electronic message is provided.

The invention provides a method and a system for filtering electronic messages capable of automatically identifying disappearing messages.

Amongst the electronic messages received by a user, some are disappearing messages and their deletion once they have become obsolete wastes the user's time.

To overcome this drawback, the electronic messages filtering technique in accordance with the invention will allow sorting out messages likely to be kept by the user in their inbox from others that are likely to be archived or deleted once they become obsolete.

To do so, the technique of the invention is based on an automatic recognition of disappearing messages featuring one or several keyword(s) indicating their disappearing nature or else which have a data field comprising an expiry or expiration date.

More specifically, the technique of the invention implements: a first mechanism for analysing the content of the electronic message with archiving of the latter when it is determined that it is actually a disappearing message, a second mechanism for detecting a label or a data field indicating the disappearing nature of said message associated to the electronic message with archiving of the latter when it is determined that it is actually a disappearing message.

Archiving may comprise moving the message to the bin.

Preferably, it is provided that the system does not automatically delete a message definitively, so that the user could reverse their decision.

In this manner, the disappearing messages are deleted on a regular basis (every week for example), or put in a particular folder prior to deletion.

Thus, this innovative method allows enhancing the well-being of employees while optimising their productivity.

According to a particular aspect of the invention, the first mechanism for analysing the content of the received electronic message is associated to a database containing examples of disappearing messages and examples of non-disappearing messages, said analysis comprising a step of querying said database, a step of comparing the content of the received electronic message with the examples of disappearing and non-disappearing messages, and a step of classifying the received electronic message as a disappearing or non-disappearing message according to the result of said comparison.

According to a particular aspect of the invention, in the case where the mechanism of analysis by querying the database detects that the received message is a disappearing message, a step of saving said received message in the database as an example of a disappearing message is provided.

According to a particular aspect of the invention, when the data field associated to the received electronic message is an expiration date of the message, the step of archiving said electronic message is implemented after said expiration date.

According to a particular aspect of the invention, the method comprises a step of saving a received message in said database as a disappearing message when said received message is deleted by the user within a predetermined time frame after having been opened for the first time.

The invention also relates to a system for processing electronic messages of a user's inbox, said system comprising at least one analysis module adapted to implement one of the following two analysis mechanisms in order to detect whether an electronic message received in said inbox is a disappearing message: a first mechanism for analysing the content of the electronic message, a second mechanism for detecting a label or a data field associated to the electronic message indicating the disappearing nature of said message, and in the case that one of the two analysis mechanisms detects that a received electronic message is a disappearing message, means for archiving said electronic message.

According to a particular aspect of the invention, the first mechanism for analysing the content of the received electronic message is associated to a database containing examples of disappearing messages and examples of non-disappearing messages, said system comprising means for querying said database, means for comparing the content of the received electronic message with the examples of disappearing and non-disappearing messages, and means for classifying the received electronic message as a disappearing or non-disappearing message according to the result of said comparison.

Advantageously, the mechanism for analysing the content of the messages is based on text mining.

Preferably, the mechanism for analysing the content of the messages uses a. Bayesian filter and the database contains lexemes each associated to a probability of being in a disappearing message.

According to a particular implementation of the invention, the system comprises means for labelling by the user an electronic message received in said inbox indicating the disappearing nature of said message.

The invention also covers a computer program including instructions for the execution of a processing method as described when said program is executed by a processor and a processor-readable storage medium on which this computer program is recorded.

### BRIEF DESCRIPTION OF THE DRAWINGS

Other objects, features and advantages of the invention will appear clearly on reading the following description, provided as a mere illustrative and non-limiting example, with reference to the figures, amongst which:

FIG. 1 schematically represents the general structure of an electronic messages processing system of an electronic messenger according to the invention;

FIG. 2 represents the main steps of an electronic messages processing method in accordance with the invention implemented by the system of FIG. 1;

FIG. 3 represents the main steps of the constitution and management cycle of the predictive filtering learning database of the system of FIG. 1;

FIG. 4 represents the main steps of the update cycle of the predictive filter of the system of FIG. 1.

### DETAILED DESCRIPTION OF CERTAIN ILLUSTRATIVE EMBODIMENTS

The invention aims to perfect the prior art by providing in particular a method that allows categorising automatically and exhaustively electronic messages (or “mail”) received by a user and which are disappearing messages.

The present patent application is intended to provide a method for detecting disappearing electronic messages, from among electronic messages in a user's inbox, wherein at least one of the following two analysis mechanisms is implemented in order to detect whether an electronic message received in said inbox is a disappearing message: a mechanism for analysing the content of the electronic message, a mechanism for detecting a label or a data field associated to the electronic message indicating the disappearing nature of said message, and in the case where one of the two analysis mechanisms detects that a received electronic message is a disappearing message, a step of archiving, or deleting, said electronic message is provided.

This method is implemented by a system or tool 2 in the form of an extension (commonly called “plugin”) which is intended to be added to a local electronic messenger or to a web messenger.

This system or tool 2 is implemented in a server or computer S comprising a processing unit comprising a processor (μP), a memory MEM, a user interface INT, and means for communication COM with a data transmission network R, such as the Internet network through which the electronic messages are transmitted towards an inbox 1.

A computer program is stored in a storage space of the memory MEM and comprises instructions for the implementation of the processing method according to one embodiment as described with reference to FIG. 2 when this program is executed by a processor. During initialisation, the instructions of the program driving the processing unit are, for example, loaded in a non-represented random-access memory (RAM for example) that the server S comprises before being executed by the processor of the processing unit.

We consider the case where the user has many disappearing messages to identify in their professional inbox 1, such as: thanks, “see you soon”, or “come have a coffee” type messages; general communication announcements (“this week at our premises, etc.”)

Using the extension (the system bearing the reference numeral 2) installed by the user, the latter can control a first analysis module adapted to train a classification filter 21 to recognise disappearing messages received in the inbox 1 via examples and counterexamples of disappearing messages.

The filter 21 may have an initial knowledge base to recognise classic cases of disappearing messages.

A second analysis module including detection means may be implemented to activate an automatic recognition of disappearing messages featuring one or several keyword(s) indicating their disappearing nature or a data field comprising an expiry or expiration date.

Thus, the extension (the system bearing the reference numeral 2) attached to the electronic messenger 1 solves the problem of automatic identification of disappearing messages in two non-exclusive ways: either through the implementation of a learner-type filter 21 (called first mechanism) for analysing the content of the messages received in the inbox 1, or through the implementation of means for detecting 22 (called second mechanism) a keyword or an expiry/expiration date field associated to the messages received in the inbox I.

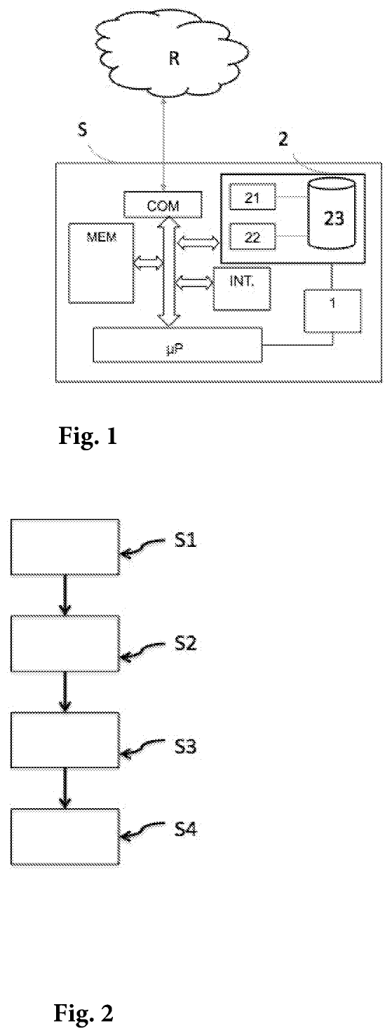

The installation represented in FIG. 1 includes a system 2 for filtering or processing electronic messages that appear in the file commonly called inbox.

These electronic messages are transmitted towards this inbox 1 via a data transmission network, such as the Internet network.

Amongst the electronic messages, some are, for example, purely promotional, or more generally undesirable, and others are disappearing messages. The filtering system 2 or tool is intended to carry out a preliminary sorting, enabling the final recipient of the electronic messages not to waste time deleting disappearing messages.

The filtering system 2 is automatically activated on a regular basis or randomly, but may also be activated on the user's request.

Amongst the disappearing messages, some are easily recognisable, because they include predefined data, known by the filtering system 2, enabling the latter to conclude that these electronic messages are most likely disappearing messages. For example, the data contained in an electronic message, that allow recognising whether it is a disappearing message, consist of links contained therein, the electronic address of the sender, the presence of “expiration date” field or of a label (commonly called “tag”) indicating its disappearing nature, as well as all words used in the body of the message or in its header.

Thus, the filtering system 2 comprises means for analysing character strings contained in the electronic messages received in the inbox, and means for classifying these electronic messages as disappearing messages based on the results provided by the analysis means.

Thus, the present invention enables the management of the electronic messages of a user by allowing a disappearing message present in the inbox of a messenger client to be archived at the appropriate time.

The disappearing messages are deleted, or put in a particular folder prior to deletion, on a regular basis, for example every weekend.

### Labelling or Standardisable Tag Method

Every electronic message can be labelled before sending thereof, either with a standardised label (or “tag”) indicating its “disappearing” nature, or with a standardised field indicating an “expiry date”.

On its arrival in the inbox 1 of the recipient, the electronic messaging processing system 2 in accordance with the invention recognises this label using the detection means 22 (so-called second mechanism) and applies the proper processing: for a label indicating the disappearing nature of a message, an embodiment consists in automatically classifying in the bin, or automatically deleting the considered message within 24 h (customisable duration); for a data field indicating an “expiry or expiration date” of a message, similarly, the processing system 2 checks up the inbox 1 on a regular basis and deletes (or classifies in the bin) every electronic message whose expiry date has passed.

### Filter Method

The learning filter 21 is an artificial intelligence module added to the messenger and is associated to human-machined interface (HMI) components enabling the user to indicate, for a selected message, whether it consists of a disappearing message (through a right mouse button click, a general-purpose button or any other conventional means to check an element of a list in a human-machine interface). These checked examples (explicit labels) constitute the set of positive examples.

In a particular embodiment, through a method for monitoring the deleted messages, the set of positive examples may be enriched with every message deleted by the user shortly after its arrival (for example, within one minute). Thus, this enrichment is done through an implicit labelling.

It should be noted that the disappearing filtering or processing system in accordance with the invention can be used, or not, downstream of an anti-spam type filter. If there is no anti-spam upstream filter, then it is likely that “spam” type messages will be processed, through the implicit labelling, like disappearing messages (and therefore cleaned, a posteriori, during the next activation of the disappearing messages filter).

In other words, the disappearing messages learning by implicit labelling (deletion of a message shortly after its arrival) does not distinguish between possible “spam” and actual disappearing messages.

This does not alter the main function of the disappearing messages filter 21, which consists in cleaning the inbox off messages that have become or are already useless.

The learning filter 21 retrieves all positive examples of disappearing messages through the interactions of the user (explicit labelling or implicit labelling).

Moreover, the filter 21 performs a sampling of the inbox 1 for all messages that have not been labelled as disappearing. These examples constitute negative examples.

According to a particular implementation, the filter 21 may be linked to a preset database 23 of typical examples and counterexamples of disappearing messages, this database 23 being fed with the set of positive examples or the set of negative examples.

Finally, if a (standardisable) element such as a conventional label or tag indicating “disappearing mail” or a data field such as “expiry or expiration date” is associated to an electronic message, the set of positive examples of the database 23 may be automatically enriched with each message containing this label (which has therefore been labelled by the sender in this case).

The positive and negative sets of the database 23 allow constituting a learning set and therefore training any type of filter based on text mining and relying on an analysis of the content of the messages (words, n-grams, metadata) and in particular of the body of the message and possibly of its header, and the user of a naive Bayesian type artificial learning algorithm, a so-called Rocchio filter, neural networks or others.

The mechanism for analysing the messages by Bayesian filtering uses a database, referred to as “dictionary”, indexing lexemes and, for each one of them, a probability of being contained in a disappearing message. A “lexeme”, also called “corpus”, refers to a word, a group of words forming an expression or a derivative of a word or of an expression constituted by a combination of letters and other elements, for example punctuation characters.

Each received message is split into lexemes, which are compared with those contained in the dictionary in order to determine the overall probability of the message being a disappearing message. If the overall probability of the message exceeds a high threshold, for example 0.7, the result of the analysis is that the message is a disappearing message. If the overall probability of the message is below a low threshold, for example 0.3, the result of the analysis is that the message is not a disappearing message. If the probability of the message is between the low and high threshold, in other words within an uncertainty range, there remains some uncertainty over the disappearing or non-disappearing nature of the message.

Once the filter 21 has been trained, it can be automatically used in a cyclic way (or on the user's request) to automatically recognise new disappearing messages, and automatically classify them, within 24 h for example (this duration being preferably customisable), in the bin or delete them.

FIG. 2 represents the following steps of a method in accordance with the invention implemented by the system of FIG. 1.

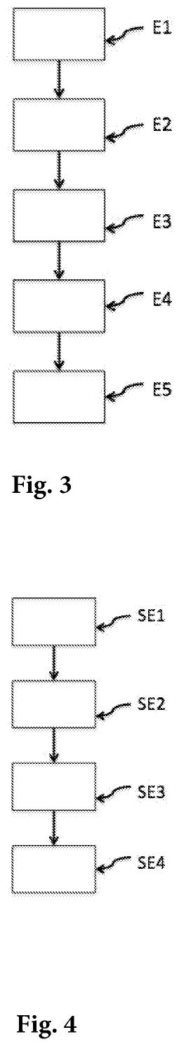

As a prelude, the constitution and management cycle A of the learning database 23 of the predictive filtering of disappearing messages received in the inbox 1 is described with reference to FIG. 3. Depending on the situation, this cycle implements the following steps.

Step E1: automatic explicit classification through a standardised labelling, and automatic sampling of counterexamples. For each message contained in the inbox 1, there is a disappearing message type standardised label, a copy of this message as a positive example is saved in the disappearing messages learning base. Otherwise, a selection of k% of the cases is implemented (k: sampling percentage, for example k=5) and a copy of these messages as negative examples is saved in the disappearing messages learning base.

Step E2: manual explicit classification: this step is activated each time the user labels a message as disappearing (through a “disappearing mail” button of the HMI that can be activated on the electronic message, or through a “drag-and-drop” of a message into a “mail classified as disappearing” folder).

Step E3: manual implicit classification: this step is activated each time an electronic message is deleted by the user: if the message has just been opened for the first time “S” seconds before (S: a user parameter, equal to 10 for example), or if the message is deleted while it has been received only “T” minutes before (T: a user parameter, equal to 20 for example), a copy of this message as a positive example is saved in the disappearing messages learning base.

E4: manual explicit correction of the system: this step is activated each time an electronic message (“mail”) that has been automatically classified in the “mail classified as disappearing” folder is manually reset by the user in the inbox, or the user uses any other interactive means (“false positive” button, etc.) to indicate that the system has made a wrong classification: a copy of this message as a negative example is saved in the disappearing messages learning base.

E5: maintenance of the learning database 23: this step is activated when the learning base has become too large with more than “N” examples (for example N=10000 mail, a parameter of the system): in this case, a reduction of the learning base by subsampling, is performed, while trying to meet a (50%/50%) balance between the positive examples and the negative examples.

The different steps of the cycle B of use of the system 2 for filtering the disappearing messages received in the inbox 1 are described hereinafter, with reference to FIG. 2.

Step S1—a step of activating the filtering system 2;

Step S2—a step of selecting an electronic message in the inbox 1;

Step S3—a step of analysing the content of the electronic message and possibly a step of detecting a label or a data field associated to the electronic message indicating the disappearing nature of said message. This step calls a text classifier type algorithm or component Which directly applies a “black box” predictive model. During the step of analysing the content of the electronic message, the text classifier type algorithm or component may implement a step of querying the database 23 associated to the learning filter 21, called disappearing messages predictive filtering learning base, comprising a step of comparing the structure of the electronic message with typical structures of disappearing messages;

Step S4—in the case where one of the two analysis mechanisms 21, 22 detects that the electronic message is a disappearing message, an automatic step of archiving or deleting said electronic message (archiving in a “classified as disappearing” folder in the case of use of the predictive filter as it allows subsequently correcting the predictive filter, where appropriate).

The different steps of the update cycle C of the predictive filter 21 are described hereinafter, with reference to FIG. 4.

Step SE1: triggering of the update of the predictive filter: this step A is implemented on a regular basis, for example every hour or every day;

Step SE2: retrieval of the examples and counterexamples of disappearing messages from the local database;

Step SE3: re-training the disappearing messages classifier (for example through a naive Bayesian, or Rocchio, type filter or a LSTM, RNN type more sophisticated system, or any other text-mining classifier);

Step SE4: saving the new learnt model for immediate reuse in the next cycle of use of the disappearing messages filtering system 2 (the above-described cycle B).

1. A method of processing disappearing electronic messages, from among electronic messages in a user's inbox, wherein at least one of the following two analysis mechanisms is implemented in order to detect whether an electronic message received in the inbox is a disappearing message: a first mechanism for analyzing content of the electronic message, a second mechanism for detecting a label or a data field associated to the electronic message indicating a disappearing nature of the message, and in a case where one of the two analysis mechanisms detects that a received electronic message is a disappearing message, archiving the electronic message is provided.

2. The method of claim 1, wherein the first mechanism for analyzing the content of the received electronic message is associated to a database containing examples of disappearing messages and examples of non-disappearing messages, the analysis comprising querying the database, comparing the content of the received electronic message with the examples of disappearing and non-disappearing messages, and classifying the received electronic message as a disappearing or non-disappearing message according to a result of the comparison.

3. The method of claim 2, wherein in a case where the mechanism of analysis by querying the database detects that the received message is a disappearing message, saving the received message in the database as an example of a disappearing message.

4. The method of claim 1, wherein when the data field associated to the received electronic message is an expiration date of the message, archiving the electronic message is implemented after the expiration date.

5. The method according to claim 2, additionally comprising saving a received message in the database (23) as a disappearing message when the received message is deleted by a user within a predetermined time frame after having been opened for a first time.

6. A system for processing electronic messages of an inbox of a user, the system comprising at least one analysis module adapted to implement one of the following two analysis mechanisms in order to detect whether an electronic message received in the inbox is a disappearing message: a first mechanism for analyzing the content of the electronic message, a second mechanism for detecting a label or a data field associated to the electronic message indicating a disappearing nature of the message, and in the a case where one of the two analysis mechanisms detects that a received electronic message is a disappearing message, means for archiving the electronic message.

7. The processing system of claim 6, wherein the first mechanism for analyzing the content of the received electronic message is associated to a database containing examples of disappearing messages and examples of non-disappearing messages, the system comprising means for querying the database, means for comparing the content of the received electronic message with the examples of disappearing and non-disappearing messages, and means for classifying the received electronic message as a disappearing or non-disappearing message according to a result of the comparison.

8. The processing system of claim 7, wherein the mechanism for analyzing the content of the messages is based on text mining.

9. The processing system of claim 8, wherein the mechanism for analyzing the content of the messages uses a Bayesian filter and the database contains lexemes each associated to a probability of being in a disappearing message.

10. The processing system of claim 6, additionally comprising means for labelling by the user an electronic message received in the inbox indicating the disappearing nature of the message.

11. A computer comprising a processor and a memory, the memory storing code instructions of a computer program including instructions to implement the processing method of claim 1 when the program is executed by a processor.

12. A non-transitory processor-readable storage medium on which the computer program of claim 11 is recorded.
